(19) United States
(12) Patent Application Publication
(10) Pub. No.: US 2026/0271898 A1
(43) Pub. Date: Sep. 17, 2026

(54) REEL SEAT AND FISHING ROD

(71) Applicant: GLOBERIDE, Inc., Higashikurume-shi, Tokyo (JP)

(72) Inventors: Kyoichi KANEKO, Higashikurume-shi (JP); Yoshinao KATO, Higashikurume-shi (JP); Masaru AKIBA, Higashikurume-shi (JP)

(73) Assignee: GLOBERIDE, Inc., Higashikurume-shi, Tokyo (JP)

(21) Appl. No.: 18/873,879

(22) PCT Filed: Apr. 20, 2023
(86) PCT No.: PCT/JP2023/015743

§ 371 Date: Dec. 11, 2024

(30) Foreign Application Priority Data
Sep. 13, 2022 (JP) 2022-145482

(51) Int. Cl. A01K 87/06; A01K 87/08

(52) U.S. Cl. CPC A01K 87/06; A01K 87/08

(57) ABSTRACT

A reel seat and fishing rod wherein the reel seat can prevent stress concentration at a rod pipe base portion. The reel seat attached to a rod body includes a main body with a reel leg placing portion, fixed hood and tubular portions on the reel leg placing portion front or rear side, and an intermediate coupling portion coupling the tubular portion and a front or rear tubular portion along the axial direction; a movable hood provided on the rear side or the front side in the axial direction of the reel leg placing portion; and a nut member on the tubular portion outer surface and enabling movement of the movable hood by rotation. In the reel seat, bending rigidity of the intermediate coupling portion of the reel seat main body is lower than or equal to rod body base portion bending rigidity of the reel seat main body.

### TECHNICAL FIELD

### Cross Reference

The present application claims priority based on Japanese Patent Application No. 2022-145482 (filed on Sep. 13, 2022), the contents of which are incorporated herein by reference in their entirety.

The present invention relates to a reel seat and a fishing rod comprising the same.

### BACKGROUND ART

Conventionally, various fishing rods including a fishing rod reel seat have been known.

In such fishing rod, a fishing rod reel seat and a fishing rod grip are usually placed on a rod body, and a reel leg placing portion for placing a reel leg on an upper side or a lower side of a main body is formed on the fishing rod reel seat.

As such a fishing rod, for example, Patent Literature 1 discloses that a base rod 1 has a high-rigidity portion X located on a rod base side of a reel seat 8 and a low-rigidity portion Y located on a tip side of the high-rigidity portion X and having lower rigidity than the high-rigidity portion X, and even when a fishing person supports the base rod 1 while gripping the vicinity of the reel seat 8 and abutting the rod base side end against the elbow or the belly, the high-rigidity portion X maintains sufficient rigidity, so that this portion is hardly curved, and the entire fishing rod can be supported by pulling the base rod 1 in a stable state.

In addition, Patent Literature 2 discloses a stretchable telescopic rod in which a reel seat 4 is attached to a base rod 2, a fishing line guide 6 is attached to a rod tip side portion 1a located on a rod tip side of a tip rod 1, the rod tip side portion 1a is configured to have higher rigidity than a rod butt side portion 1b located on a rod butt side of the rod tip side portion 1a, the rod butt side portion 1b is held in a state of being stored in the base rod 2, the rod butt side portion 1b is configured to be capable of being held in an extended state of being pulled out toward the rod tip side of the base rod 2, and the rod butt side portion 1b is easily bent by being pulled by a fish in the extended state.

### CITATION LIST

### Patent Literature

Patent Literature 1: JP 2002-84928 A
Patent Literature 2: JP 2008-263843 A

### SUMMARY OF INVENTION

### Technical Problem

Conventionally, a fishing rod having a structure in which the rigidity of a tip portion of a reel seat main body is higher than the rigidity of a base portion of a rod pipe is used. In particular, in a fishing rod using an offset reel seat, in a case where a structure in which a rod pipe does not pass through the offset reel seat is adopted, the rigidity of the reel seat main body is increased by forming the reel seat main body using a metal material in order to maintain the strength of the reel seat, or by increasing the thickness and securing the strength in a case of a resin material. However, it has been found that, in a case where a load is applied to the rod pipe, if the rigidity of the front end of the reel seat to which the rod pipe is joined is high, stress concentration occurs on the rod pipe of the reel seat tip portion, and a problem that the rod pipe easily breaks occurs. In this respect, the base rod according to Patent Literature 1 has a problem that stress concentration occurs in the low-rigidity portion Y having lower rigidity than the high-rigidity portion X located on the tip side of the high-rigidity portion X. On the other hand, the fishing rod according to Patent Literature 2 is only made to have higher rigidity than the rod butt side portion located closer to the rod butt side than the rod tip side portion, and the problem that stress concentration occurs in the rod pipe of the reel seat tip portion and the rod pipe easily breaks cannot be solved.

The present invention has been made in view of the above circumstances, and an object thereof is to provide a reel seat and a fishing rod comprising the same, in which, even in a case of adopting a structure in which a position of a reel leg placing portion of the reel seat is offset in a direction of falling down with respect to an axial center of a base rod is adopted, it is possible to prevent occurrence of stress concentration at a rod pipe base portion by adjusting bending rigidity at a tubular portion and an intermediate coupling portion of the reel seat, so that the rod pipe base portion is hard to break even with the offset structure, and it is possible to greatly increase durability and strength of the rod. Other objects of the present invention will become apparent upon reference to the entirety of the present specification.

### Solution to Problem

A reel seat according to one embodiment of the present invention is a reel seat attached to a rod body, the reel seat comprising: a reel seat main body comprising a reel leg placing portion on which a reel leg is placed, a fixed hood provided on a front side or a rear side in an axial direction of the reel leg placing portion, a tubular portion provided on the rear side or the front side in the axial direction of the reel leg placing portion, and an intermediate coupling portion coupling the tubular portion and a front or rear tubular portion along the axial direction; a movable hood provided on the rear side or the front side in the axial direction of the reel leg placing portion; and a nut member provided on an outer surface of the tubular portion and enabling movement of the movable hood by rotation. In the reel seat, bending rigidity of the intermediate coupling portion of the reel seat main body is lower than or equal to bending rigidity of a base portion of the rod body.

In the reel seat according to one embodiment of the present invention, the bending rigidity of the intermediate coupling portion of the reel seat main body with respect to the bending rigidity of the base portion of the rod body in a downward direction of an up-down direction of the reel seat ranges from 0.8 to 1.0.

In the reel seat according to one embodiment of the present invention, bending rigidity of a lower portion of a reel placing portion of the reel seat main body is set to be four to six times in a transverse direction with respect to a longitudinal direction thereof.

A fishing rod according to one embodiment of the present invention comprises the reel seat according to any one of the above descriptions; and a rod body.

### Advantageous Effects of Invention

According to the above embodiment, it is possible to provide a reel seat and a fishing rod comprising the same, in which, even in a case of adopting a structure in which a position of a reel leg placing portion of the reel seat is offset in a direction of falling down with respect to an axial center of a base rod is adopted, it is possible to prevent occurrence of stress concentration at a rod pipe base portion by adjusting bending rigidity at a tubular portion and an intermediate coupling portion of the reel seat, so that the rod pipe base portion is hard to break even with the offset structure, and it is possible to greatly increase durability and strength of the rod.

### BRIEF DESCRIPTION OF DRAWINGS

FIG. 1 is a view illustrating a fishing rod according to one embodiment of the present invention.

FIG. 2 is a diagram illustrating a reel seat according to one embodiment of the present invention.

FIG. 3 is an exploded perspective view of the reel seat according to one embodiment of the present invention.

FIG. 4 is a cross-sectional view of the reel seat according to one embodiment of the present invention.

FIG. 5 is a cross-sectional view of the reel seat according to one embodiment of the present invention.

FIG. 6(a) is an upward perspective view of a movable hood in the reel seat according to one embodiment of the present invention. FIG. 6(b) is a downward perspective view of the movable hood in the reel seat according to one embodiment of the present invention.

FIG. 7 is a diagram for explaining bending rigidity of the reel seat 9 according to one embodiment of the present invention.

### DESCRIPTION OF EMBODIMENTS

Hereinafter, embodiments of a reel seat and a fishing rod according to the present invention will be specifically described with reference to the accompanying drawings. Components that are common in a plurality of drawings are denoted by the same reference signs throughout the plurality of drawings. It should be noted that each drawing is not necessarily drawn to an accurate scale for the sake of convenience in description.

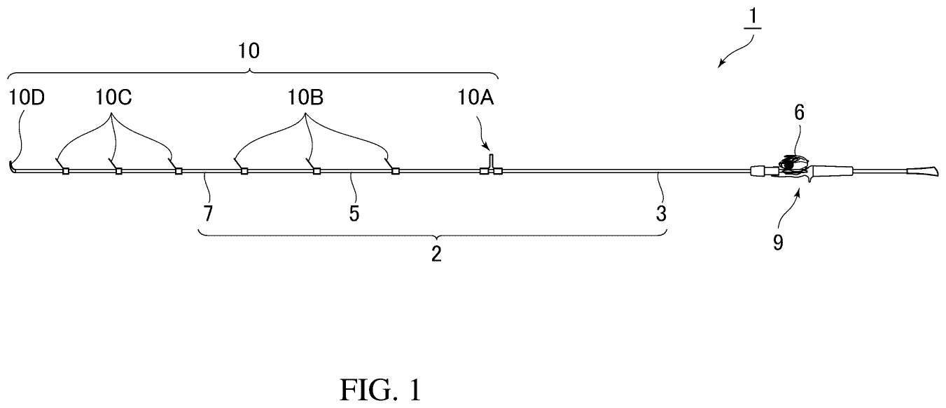

FIG. 1 is a view illustrating an embodiment of a fishing rod according to the present invention. As illustrated in the drawing, a fishing rod 1 according to the embodiment of the present invention comprises a rod body 2, a reel 6 attached to the rod body 2 via a reel seat 9, and a fishing line guide 10 attached to the rod body 2. In the illustrated embodiment, each of the reel seat 9 and the fishing line guide 10 corresponds to an attachment component attached to an outer peripheral surface of the rod body.

The rod body 2 is constituted by, for example, coupling a base rod 3, a middle rod 5, a tip rod 7, and the like to each other. These rod bodies are jointed to each other, for example, as an ordinarily jointed type. The base rod 3, the middle rod 5, and the tip rod 7 can be jointed to each other as a telescopic type, an inversely jointed type, a socket-and-spigot jointed type, or any other known jointed type. The rod body 2 may be formed of a single rod body.

Each of the base rod 3, the middle rod 5, and the tip rod 7 is formed of, for example, a tubular body made of a fiber-reinforced resin. This tubular body made of a fiber-reinforced resin is produced by winding a fiber-reinforced resin prepreg (prepreg sheet) obtained by impregnating reinforcing fibers with a matrix resin around a core metal, and heating and curing the prepreg sheet. As the reinforcing fibers contained in the prepreg sheet, for example, carbon fibers, glass fibers, and any other known reinforcing fibers can be used. As the matrix resin contained in the prepreg sheet, a thermosetting resin such as an epoxy resin can be used. After the prepreg sheet is cured, the core metal is removed. An outer surface of the tubular body is appropriately polished. Each of the rod bodies may be formed in a solid state.

In the illustrated embodiment, the base rod 3, the middle rod 5, and the tip rod 7 comprise a plurality of the fishing line guides 10 (fishing line guides 10A to 10D) for guiding a fishing line fed from the reel 6 attached to the reel seat 9. More specifically, the base rod 3 is provided with the fishing line guide 10A, the middle rod 5 is provided with the fishing line guide 10B, and the tip rod 7 is provided with the fishing line guide 10C. The tip rod 7 comprises the top guide 10D at a front end thereof, but details thereof are omitted.

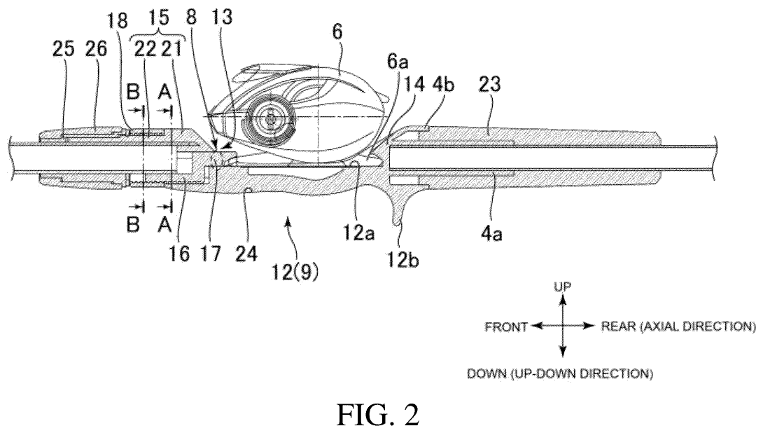

Next, a basic configuration of a reel seat main body 12 and the reel seat 9 will be described with reference to FIG. 2. In the following description, an axial direction (front-rear direction) and an up-down direction mean directions illustrated in FIG. 2, and a right-left direction (side direction) mean a direction orthogonal to a sheet surface of FIG. 2. That is, a front side and a rear side means a tip rod side and a proximal end side of the fishing rod, respectively, an upper side means a reel side with respect to an axial center X of a base rod (rod) when a double-bearing reel is attached, and a lower side means an opposite side of the reel side.

The reel seat main body 12 comprises the reel seat main body 12 comprising a reel leg placing surface 12a on which a reel leg 6a of the fishing reel 6 is placed in an axial direction thereof. The reel seat main body 12 can be formed to have a length ranging from 150 mm to 200 mm, for example, but is not limited thereto. In addition, the reel seat main body 12 forms a bulging portion (trigger) 12b that is a slightly bulged portion from the opposite side of the reel leg placing surface 12a and has an easy-to-grip curved outer surface that supports a thenar and an area near the thenar when gripped with a gripping hand. Note that, the rod body may be jointed on a rear side of the reel seat main body 12.

The reel leg placing surface 12a of the reel seat main body 12 can be formed flat or substantially flat with a larger curvature than that of other sites in a circumferential direction (for example, the trigger 12b) adjacent to the reel leg placing surface 12a of the reel seat main body 12, and is formed to extend in the axial direction of the reel seat main body 12 illustrated in FIG. 2. A fixed hood 14 is integrally disposed on one end (rod base side) of the reel seat main body 12. One end of the reel leg placing surface 12a of the reel seat main body 12 is disposed inside the fixed hood 14.

A movable hood 13 is attached to the other end (rod tip side) of the reel seat main body 12 so as to be movable in the axial direction. A fishing reel 200 is attached and fixed to the reel seat 9 by placing the reel leg 6a on the reel leg placing portion 12a and fastening a front end side thereof by the movable hood 13 moving in the axial direction in a state in which a rear end side thereof is fitted in the fixed hood 14. Note that, the reel seat 9 comprises the reel seat main body 12 and the movable hood 13, but may comprise other members.

The reel seat according to one embodiment of the present invention will be described in more detail with reference to FIG. 2 again. As illustrated in the drawing, the reel seat 9 according to one embodiment of the present invention is the reel seat 9 attached to the rod body 2, the reel seat 9 comprising: the reel seat main body 12 comprising the reel leg placing portion 12a on which the reel leg 6a is placed, the fixed hood 14 provided on a rear side (rod butt side) in the axial direction of the reel leg placing portion 12a, and a tubular portion 15 partially cut out provided on a front side (rod tip side) in the axial direction of the reel leg placing portion 12a; the movable hood 13 provided on the front side (rod tip side) in the axial direction of the reel leg placing portion 12a; and a nut member 18 provided on an outer surface of the tubular portion 15 and enabling movement of the movable hood 13 by rotation. In the reel seat 9, the tubular portion 15 comprises a cylindrical portion 21 and a recessed portion 22 partially cut out, the movable hood 13 includes an engaging portion 16 provided on an inner surface of the tubular portion 15 and a hood portion 17 accommodating at least a part of the reel leg 6a, the nut member 18 is provided on an outer surface of the recessed portion 22 so as to be relatively rotatable with respect to the recessed portion 22, an inner surface 18a of the nut member 18 engages with the engaging portion 16 so that the movable hood 13 can be moved to the rear side (rod butt side) in the axial direction by the rotation of the nut member 18, and the rod body 2 is formed to be insertable into the cylindrical portion 21 of the tubular portion 15.

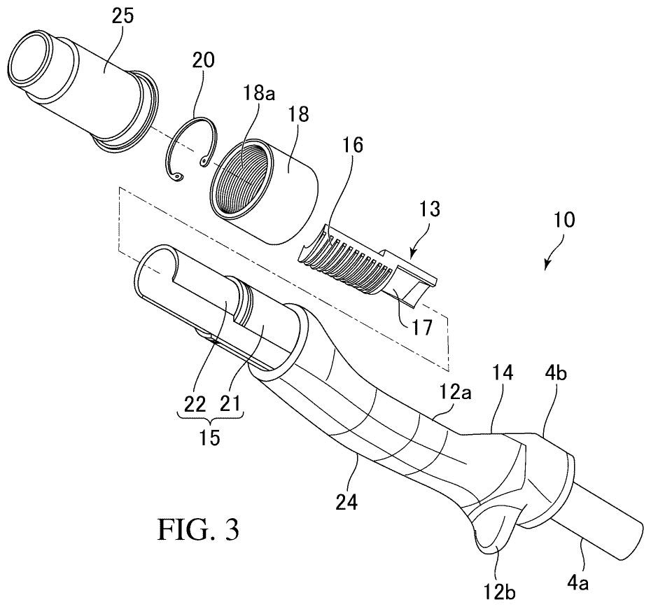

Next, the reel seat according to one embodiment of the present invention will be further described with reference to FIGS. 2 and 3. The reel seat main body 12 of the reel seat 9 comprises the tubular portion 15 on a front side, and a grip portion (rear grip) 23 gripped and held is fixed to a rear side. The reel seat main body 12 comprises an intermediate coupling portion 24 that couples the tubular portion 15 and a rear tubular portion 4b in the axial direction, and they are integrally formed. A proximal end side outer peripheral surface of the rod body 2 forming the fishing rod is fixed to the inner surface of the tubular portion 15 by adhesion or the like, and the grip portion 23 is fixed to an outer peripheral surface of a tubular projection 4a formed to protrude in the axial direction on the rear side of the reel seat main body 12, and is formed to be flush with a surface of the rear tubular portion 4b. In this case, the rear tubular portion 4b is also a portion gripped and held together with the grip portion 23, and can form a grip. Note that, the configuration of the fishing rod 1 to which the reel seat 9 is fixed is not limited and may be a telescopic type, a jointed type, a single body type, and the like, and in FIG. 2, a part of the fishing rod (a part of the rod body) is illustrated, and an entire configuration is omitted. An example in which, a double-bearing reel (hereinafter, also referred to as a reel) of a low profile type is attached and fixed as the fishing reel 6 to the reel seat 9 is illustrated.

The movable hood 13 comprises the engaging portion 16 in which a male screw portion is formed, and the hood portion 17 curved radially inward to accommodate at least a part of the reel leg 6a. The hood portion 17 is disposed so as to enter an opening 8 formed below a front end face of the intermediate coupling portion 24 (an end face of the tubular portion 15), and the opening 8 is connected to the reel leg placing portion 12a. That is, when the movable hood 13 moves rearward, the hood portion 17 thereof is fitted in a front end of the reel leg 6a placed on the reel leg placing portion 12a in the opening 8.

The male screw portion of the engaging portion 16 of the movable hood 13 is screwed with a female screw portion formed on the inner surface 18a of the nut member 18 externally fitted to the tubular portion 15 (or the recessed portion 22 of the tubular portion 15). That is, when the nut member 18 is rotationally operated in one direction, the movable hood 13 moves to the rear side in the axial direction to fasten the front end side of the reel leg 6a (attached and fixed state of the reel), and when the nut member 18 is rotationally operated in the other direction, the movable hood 13 moves to the front side in the axial direction to release the front end side of the reel leg 6a (detached state of the reel). Here, various methods known conventionally are possible as a method of engaging the engaging portion 16 with the inner surface of the nut member 18, and the method is not limited to a specific mode (screwing). Note that, a circumferential groove is formed in a circumferential direction on the front end side of the tubular portion 15, and by attaching a ring-shaped member (stop ring) 20 to this portion, it is possible to restrict the nut member 18 from coming off to the front side.

On an outer surface of the reel seat main body 12, a grip support portion 25 is adhered adjacent to the nut member 18, and a grip portion (front grip) 26 is fixed on the grip support portion 25 to be flush with a surface of the nut member 18 operated to be rotated; however, a configuration without the grip portion 26 provided is also possible.

Next, a cross-sectional structure of the reel seat 9 according to one embodiment of the present invention will be described with reference to FIG. 5. FIG. 5 illustrates an A-A cross section of FIG. 2. As illustrated in the drawing, in the reel seat 9 according to one embodiment of the present invention, in a state in which the rod body 2 is inserted (and in a case where the movable hood 13 is at the position of FIG. 2), when a cross section perpendicular to the axial direction of the tubular portion 15 is seen in a downward direction from the central axis of the tubular portion 15 (downward direction in the up-down direction of the sheet surface of FIG. 5), the rod body 2, the movable hood (the engaging portion 16), and the reel seat main body 12 (the tubular portion 15 or the cylindrical portion 21) are provided in order from the inner side. As illustrated in the drawing, the cylindrical portion 21 of the tubular portion 15 of the reel seat main body 12 has a circular or substantially circular outer surface, and an inner surface forms a space capable of accommodating the cylindrical rod body 2 and the engaging portion 16 formed by curving. Various shapes of the inner side of the cylindrical portion 21 are possible depending on a dimension of the rod body and a shape of the engaging portion 16, and are not limited to a specific mode.

In this manner, in the reel seat 9 according to one embodiment of the present invention, since the rod body 2 can be inserted into a thicker portion (the cylindrical portion 21 of the tubular portion 15 is thicker than the recessed portion 22) of the reel seat main body of the reel seat main body 12, even in a case where the structure in which the position of the reel leg placing portion of the reel seat is offset in the direction of falling down with respect to the axial center of the base rod is adopted, it is possible to provide the reel seat capable of supporting both the round and low profile double-bearing reels, being less likely to be deteriorated in strength, and significantly improving durability.

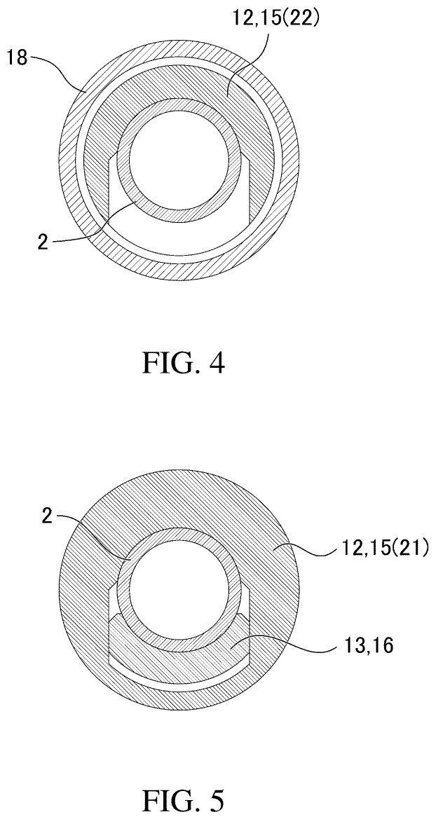

Next, a cross-sectional structure of the reel seat 9 according to one embodiment of the present invention will be described with reference to FIG. 4. FIG. 4 illustrates a B-B cross section of FIG. 2. As illustrated in the drawing, in the reel seat 9 according to one embodiment of the present invention, in a state in which the rod body 2 is inserted (and in a case where the movable hood 13 is at the position of FIG. 2), the rod body 2, the reel seat main body 12 (the tubular portion 15 or the recessed portion 22), and the nut member 18 are provided in order from the inner side when the cross section perpendicular to the axial direction of the tubular portion 15 is seen in an upward direction from the central axis of the tubular portion 15 (the upward direction in the up-down direction of the sheet surface of FIG. 4), and the rod body 2 and the nut member 18 are provided in order from the inner side when the cross section perpendicular to the axial direction of the tubular portion 15 is seen in a downward direction from the central axis of the tubular portion 15 (downward direction in the up-down direction of the sheet surface of FIG. 4), and a space through which the movable hood 13 passes is formed between the rod body 2 and the nut member 18. In this manner, the engaging portion 16 of the movable hood 13 can move the cutout portion of the recessed portion 22 of the tubular portion 15 back and forth in the axial direction of the reel seat 9. Here, as illustrated in FIG. 4, the recessed portion 22 is formed into a recessed shape having an opening in the downward direction, thereby reducing a weight of the tubular portion 15 of the reel seat main body 12. In this manner, the tubular portion 15 comprises the cylindrical portion 21 and the recessed portion 22, and does not form a complete tubular shape, but can be said to be the tubular portion 15 partially cut out (the same applies throughout the present specification).

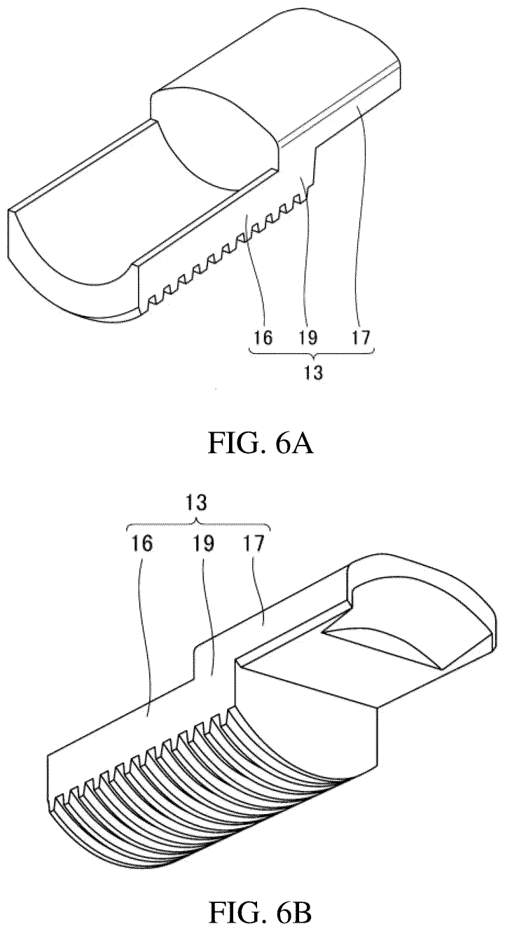

Next, with reference to FIG. 6, a structure of the movable hood 13 in the reel seat 9 according to one embodiment of the present invention will be described. FIGS. 6(a) and 6(b) are perspective views (the former is seen from obliquely above, and the latter is seen from obliquely below). As illustrated in the drawings, the movable hood 13 comprises the engaging portion 16 and the hood portion 17, and the engaging portion 16 is formed into an arc shape or a curved shape as seen in the cross section (cross section illustrated in FIG. 4) perpendicular to the axial direction of the tubular portion 15. In this manner, the inner surface is in close contact with and securely adhered to the surface of the rod body 2, and the male screw portion provided on the outer surface can be screwed with the female screw portion formed on the inner surface 18a of the nut member 18. The engaging portion 16 of the movable hood 13 is formed into an arc shape having an angle ranging from 70 degrees to 90 degrees.

As illustrated in FIG. 6, in the movable hood 13 in the reel seat according to one embodiment of the present invention, the engaging portion 16 and the hood portion 17 are offset from each other as seen in a radial direction of the central axis of the reel seat 9 (the hood portion 17 is formed inside the engaging portion 16 as seen in the radial direction of the central axis of the reel seat 9). In a case where the engaging portion 16 and the hood portion 17 are offset, a connecting portion 19 extending perpendicularly to the central axis of the reel seat 9 and connecting the engaging portion 16 and the hood portion 17 is included between the engaging portion 16 and the hood portion 17. By adjusting a length of the connecting portion 19 in this manner, the rod body itself can be inserted up to a portion where the reel seat main body has a thick structure.

The reel seat 9 according to one embodiment of the present invention is the reel seat 9 attached to the rod body 2, the reel seat 9 comprising: the reel seat main body 12 comprising the reel leg placing portion 12a on which the reel leg 6a is placed, the fixed hood 14 provided on the front side or the rear side in the axial direction of the reel leg placing portion 12a, the tubular portion 15 provided on the rear side or the front side in the axial direction of the reel leg placing portion 12a, and the intermediate coupling portion 24 coupling the tubular portion 15 and the front or rear tubular portion 4b along the axial direction; the movable hood 13 provided on the rear side or the front side in the axial direction of the reel leg placing portion 12a; and the nut member 18 provided on an outer surface of the tubular portion 15 and enabling movement of the movable hood by rotation. In the reel seat 9, the bending rigidity of the intermediate coupling portion 24 of the reel seat main body 12 is lower than or equal to the bending rigidity of the base portion of the rod body.

According to the reel seat 9 according to one embodiment of the present invention, it is possible to provide a reel seat and a fishing rod comprising the same, in which, even in a case of adopting a structure in which a position of a reel leg placing portion of the reel seat is offset in a direction of falling down with respect to an axial center of a base rod is adopted, it is possible to prevent occurrence of stress concentration at a rod pipe base portion by adjusting the bending rigidity at a tubular portion and an intermediate coupling portion of the reel seat, so that the rod pipe base portion is hard to break even with the offset structure, and it is possible to greatly increase the durability and strength of the rod.

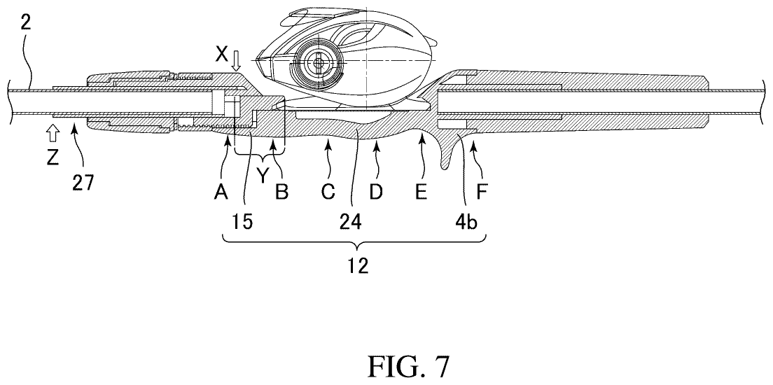

In the reel seat 9 according to one embodiment of the present invention, the bending rigidity of the intermediate coupling portion 24 of the reel seat main body 12 with respect to the bending rigidity of the tubular portion 15 of the reel seat main body 12 in the downward direction of the up-down direction of the reel seat 9 (the same applies to the up-down direction illustrated in FIG. 2 (up-down direction illustrated in FIG. 7 to be described later)) ranges from 0.8 to 1.0. In this manner, the durability (or the strength) of the rod can be improved.

In the reel seat 9 according to one embodiment of the present invention, the bending rigidity of a lower portion of a reel placing portion of the reel seat main body is set to be four to six times in a transverse direction with respect to a longitudinal direction thereof. In this manner, casting accuracy can be improved.

Next, the reel seat 9 according to one embodiment of the present invention will be further described with reference to FIG. 7. FIG. 7 and the following table illustrate the bending rigidity at each position seen in the extending direction of the reel seat. A position A is a position of a nut engaging portion of the tubular portion 15, and a position B is a position of a front portion of a reel stand of the tubular portion 15. A position C is a position of a minimum rigid portion of a reel stand lower portion of the intermediate coupling portion 24, a position D is a position of a convex portion of the reel stand lower portion of the intermediate coupling portion 24, and a position E is a position of a trigger front portion of the intermediate coupling portion 24. A position F is a position of a coupling portion of the rear tubular portion 4b with the grip. A position X is a position of a rear end of the base rod pipe (aligning member), a range Y is a range between the base rod pipe (aligning member) and the reel stand front portion, and a position Z is a position of stress concentration of the base rod pipe (base portion of the rod body) of the aligning member 27.

As illustrated in the following table, the bending rigidities (up-down direction) at the position B and the position F is 63.7 and 66.9, respectively, and are configured to be larger than those at the other positions. At the position A, the bending rigidity (up-down direction) is lower than those at the position B and the position F, but is 42.8. At the positions C, D, and E, the bending rigidities (up-down direction) are 5.1, 7.6, and 6.4, respectively, which are lower than that at the position B. In this manner, the minimum rigidity can be made lower than the rod pipe base portion rigidity of 6.0. In addition, the bending rigidities (transverse direction) at the positions C, D, and E are 27.5, 33.0, and 33.9, respectively, and it is found that the bending rigidity is 4.9 times to 5.4 times with respect to the up-down direction.

| Position | | A | B | C | D | E | F |
|---|---|---|---|---|---|---|---|
| Up-down | (EI 10\hat{ }6 | 42.8 | 63.7 | 5.1 | 7.6 | 6.4 | 66.9 |
| direction | kgf/mm²) | | | | | | |
| Transverse | (EI 10\hat{ }6 | | | 27.5 | 33.0 | 33.9 | |
| direction | kgf/mm²) | | | | | | |

At the time of fishing with the fishing rod comprising the reel seat according to one embodiment of the present invention, when the fishing reel is directed upward, a force is applied downward to the tip. At this time, since stress is concentrated in the range of Y and breakage easily occurs, it is necessary to increase the bending rigidity. On the other hand, it is known that, when the bending rigidity of the entire reel seat main body 12 is increased, stress concentrates in the vicinity of the position Z and breakage easily occurs. Therefore, it is possible to prevent stress concentration at the position Z by reducing the bending rigidity of the lower side of the reel seat main body 12 and the reel leg placing portion 12a. In addition, in order to prevent that the entire reel seat lower portion is bent, the stress is concentrated on a specific portion of the reel seat lower portion, and the durability (or the strength) of the reel seat is deteriorated, the bending rigidity at the convex portion at the finger hooking position D and the position E near the front end of the reel leg 6a is decreased. The minimum bending rigidity of the reel seat main body 12 is 80% to 100% of the bending rigidity at the position Z. In addition, the fishing rod is swung in the transverse direction of the reel seat main body 12 at the time of throwing (casting), but the bending rigidity of the reel seat main body 12 in the transverse direction is increased in order to reduce the shake at the time of throwing (casting). Specifically, by setting the bending rigidity value as described above, casting accuracy can be improved.

The fishing rod 1 according to one embodiment of the present invention comprises the reel seat 9 according to any one of the above descriptions; and the rod body 2.

According to the fishing rod comprising the reel seat according to one embodiment of the present invention, it is possible to provide a reel seat and a fishing rod comprising the same, in which, even in a case of adopting a structure in which a position of a reel leg placing portion of the reel seat is offset in a direction of falling down with respect to an axial center of a base rod is adopted, it is possible to prevent occurrence of stress concentration at a rod pipe base portion by adjusting bending rigidity at a tubular portion and an intermediate coupling portion of the reel seat, so that the rod pipe base portion is hard to break even with the offset structure, and it is possible to greatly increase durability and strength of the rod.

Here, in the reel seat 9 according to one embodiment of the present invention, the reel seat main body 12 can be formed of carbon fiber reinforced plastic (CFRP), glass reinforced plastic (GFRP), Al, or Mg. The reel seat main body 12 may be formed of a material such as GFRTP (continuous fiber), GFRTP (discontinuous fiber), CFRTP (continuous fiber), CFRTP (discontinuous fiber), or a hybrid. By forming the reel seat using such a material, it is possible to suppress an increase in weight while ensuring sufficient rigidity and strength.

Dimensions, materials, and arrangements of the components described in the present specification are not limited to those explicitly described in the embodiments, and the components may be modified to have any dimensions, materials, and arrangements that may fall within the scope of the present invention. In addition, components not explicitly described in the present specification can also be added to the described embodiments, or some of the components described in each of the embodiments can be omitted.

### REFERENCE SIGNS LIST

1 Fishing rod
2 Rod body
3 Base rod
4a Tubular projection
4b Rear tubular portion
5 Middle rod
6 Reel
6a Reel leg
7 Tip rod
8 Opening
9 Reel seat
10 Fishing line guide
12 Reel seat main body
12a Reel leg placing surface
13 Movable hood
14 Fixed hood
15 Tubular portion
16 Engaging portion
17 Hood portion
18 Nut member
18a Inner surface of nut member
19 Connecting portion
20 Ring-shaped member
21 Cylindrical portion
22 Recessed portion
23 Grip portion (rear grip)
24 Intermediate coupling portion
25 Grip support portion
26 Grip portion (front grip)
27 Aligning member

1. A reel seat that is attached to a rod body, the reel seat comprising: a reel seat main body comprising a reel leg placing portion on which a reel leg is placed, a fixed hood provided on a front side or a rear side in an axial direction of the reel leg placing portion, a tubular portion provided on the rear side or the front side in the axial direction of the reel leg placing portion, and an intermediate coupling portion coupling the tubular portion and a front or rear tubular portion along the axial direction; a movable hood provided on the rear side or the front side in the axial direction of the reel leg placing portion; and a nut member provided on an outer surface of the tubular portion and enabling movement of the movable hood by rotation, wherein
bending rigidity of the intermediate coupling portion of the reel seat main body is lower than or equal to bending rigidity of a base portion of the rod body.

2. The reel seat according to claim 1, wherein
the bending rigidity of the intermediate coupling portion of the reel seat main body with respect to the bending rigidity of the base portion of the rod body in a downward direction of an up-down direction of the reel seat ranges from 0.8 to 1.0.

3. The reel seat according to claim 1, wherein
bending rigidity of a lower portion of a reel placing portion of the reel seat main body is set to be four to six times in a transverse direction with respect to a longitudinal direction thereof.

4. A fishing rod comprising the reel seat according to claim 1; and a rod body.
